(19) United States
(12) Patent Application Publication
(10) Pub. No.: US 2015/0188644 A1
(43) Pub. Date: Jul. 2, 2015

(54) METHOD AND APPARATUS FOR MITIGATING SATELLITE DOWNLINK INTERFERENCE OF SATELLITE AND TERRESTRIAL INTEGRATED SYSTEM

(71) Applicant: Electronics and Telecommunications Research Institute, Daejeon (KR)

(72) Inventors: Kunseok KANG, Daegu (KR); Tae Chul HONG, Daejeon (KR); Hee Wook KIM, Daejeon (KR); Bon Jun KU, Daejeon (KR)

(21) Appl. No.: 14/302,941

(22) Filed: Jun. 12, 2014

(30) Foreign Application Priority Data
Dec. 30, 2013 (KR) 10-2013-0167363

(51) Int. Cl. H04B 15/00; H04W 72/04; H04W 24/10; H04B 7/204

(52) U.S. Cl. CPC H04B 15/00; H04B 7/2041; H04W 72/0453; H04W 24/10

(57) ABSTRACT

A method in which a satellite or a terrestrial earth station that is included in a satellite communication system that shares a frequency resource with a terrestrial communication system allocates a frequency resource is provided. The satellite divides an area of a first satellite beam into at least one sector. The satellite determines a first sector in which a satellite terminal is located among the at least one sector. The satellite determines a second sector corresponding to the first sector among at least one sector that is included in a first terrestrial cell. The satellite allocates at least one of first frequency resources for the second sector to the satellite terminal. The first terrestrial cell is located within an area of a second satellite beam adjacent to the first satellite beam.

### CROSS-REFERENCE TO RELATED APPLICATION

This application claims priority to and the benefit of Korean Patent Application No. 10-2013-0167363 filed in the Korean Intellectual Property Office on Dec. 30, 2013, the entire contents of which are incorporated herein by reference.

### BACKGROUND OF THE INVENTION

(a) Field of the Invention

The present invention relates to a method and apparatus for mitigating satellite downlink interference in a satellite and terrestrial integrated network.

(b) Description of the Related Art

In a multiple beam environment, as satellite communication systems between adjacent beams use different frequencies, interference between beams does not occur. In a frequency band available in both a satellite communication system and a terrestrial communication system, in a satellite and terrestrial integrated network, a terrestrial communication system (e.g., a terrestrial mobile communication system) within an adjacent satellite beam may reuse a frequency that is used in one satellite beam. A frequency that may be used in both of the satellite communication system and the terrestrial communication system presently exists, and a method of using such a frequency is determined according to a policy of each country. When the satellite and terrestrial integrated network shares and uses a frequency, if a terrestrial communication system within an adjacent satellite beam area uses a frequency that is used in one satellite beam, use of a frequency may be further improved.

In a satellite and terrestrial integrated network in which the satellite communication system and the terrestrial communication system share and use a frequency, in order to share a frequency, in a specific beam of a multiple beam satellite, a terrestrial communication system within the specific beam uses the remaining frequency bands, except for a frequency band that the satellite uses. In this case, by a downlink signal that is transmitted by terrestrial base stations that are located within a satellite beam area adjacent to the specific beam, interference occurs in a downlink signal that a satellite terminal receives from a satellite.

### SUMMARY OF THE INVENTION

The present invention has been made in an effort to provide a method and apparatus that can mitigate interference between a satellite communication system and a terrestrial communication system in a satellite and terrestrial integrated network.

An exemplary embodiment of the present invention provides a method in which a satellite or a terrestrial earth station that is included in a satellite communication system that shares a frequency resource with a terrestrial communication system allocates a frequency resource. The method includes: dividing an area of a first satellite beam into at least one sector; determining a first sector at which a satellite terminal is located among the at least one sector; determining a second sector corresponding to the first sector among at least one sector that is included in a first terrestrial cell; and allocating at least one of first frequency resources for the second sector to the satellite terminal. The first terrestrial cell is located within an area of a second satellite beam adjacent to the first satellite beam.

The number of sectors that are included in the first terrestrial cell may be N (N is a natural number). The dividing of an area may include dividing the area of the first satellite beam into N areas.

A frequency resource that is allocated to the first satellite beam may be different from a frequency resource that is allocated to the second satellite beam.

Remaining frequency resources, except for a frequency resource that is allocated to the second satellite beam, among at least one frequency resource may be divided into the N number of sectors that are included in the first terrestrial cell.

The determining of a second sector may include determining a sector in which interference intensity with the satellite terminal is weakest among the N number of sectors that are included in the first terrestrial cell as the second sector.

The determining of a second sector may include measuring an angle between a center of each sector that is included in the first terrestrial cell and the satellite terminal.

The determining of a second sector may further include determining a sector having a larger angle than a threshold angle among the measured angles as the second sector.

The determining of a second sector may further include determining a sector having a largest angle among the measured angles as the second sector.

The satellite terminal may be separated by a threshold distance or more from the center of the first satellite beam.

Another embodiment of the present invention provides a satellite that is included in a satellite communication system that shares a frequency resource with a terrestrial communication system. The satellite includes: a memory; and a processor that is connected to the memory and that performs operation for allocating a frequency resource to a satellite terminal. The processor may determine a first sector at which a satellite terminal is located among N (N is a natural number) sectors that are included in a first satellite beam of the satellite, determine a second sector corresponding to the first sector among N sectors that are included in a first terrestrial cell of the terrestrial communication system, and allocate at least one of frequency resources for the second sector to the satellite terminal. The first terrestrial cell may be located within an area of a second satellite beam of the satellite adjacent to the first satellite beam.

Yet another embodiment of the present invention provides a method in which a base station (BS) of a terrestrial communication system that shares a frequency with a satellite communication system allocates a frequency resource. The method includes: determining a frequency resource that is allocated to a second satellite beam adjacent to a first satellite beam at which the BS is located; and allocating at least one of first frequency resources, except for frequency resources that are allocated to the first satellite beam and the second satellite beam among M (M is the natural number of 2 or more) frequency resources, to at least one terrestrial terminal of the terrestrial communication system.

The method may further include allocating at least one of frequency resources that are allocated to the second satellite beam to at least one terrestrial terminal of the terrestrial communication system, when a frequency resource to allocate is insufficient.

The BS may be located within a threshold distance from a boundary of the second satellite beam.

The allocating of at least one of first frequency resources may include excluding a frequency resource that is allocated to a third satellite beam adjacent to the first satellite beam from the first frequency resource.

### BRIEF DESCRIPTION OF THE DRAWINGS

FIG. 1 is a diagram illustrating a method of dividing and using a frequency between a satellite communication system and a terrestrial communication system.

FIG. 2 is a diagram illustrating a frequency band in a satellite and terrestrial integrated network.

FIG. 3 is a diagram illustrating received signal interference of a satellite terminal by a terrestrial base station.

FIG. 4 is a diagram illustrating a radiation pattern of a terrestrial base station sector antenna.

FIG. 5 is a diagram illustrating a method of allocating a resource of a satellite according to an exemplary embodiment of the present invention.

FIG. 6 is a flowchart illustrating a resource allocation process of a satellite according to an exemplary embodiment of the present invention.

FIG. 7 is a diagram illustrating a method of allocating a resource of a terrestrial base station according to an exemplary embodiment of the present invention.

FIG. 8 is a diagram illustrating an example of frequency resource allocation between two adjacent satellite beams of FIG. 7.

FIG. 9 is a diagram illustrating a configuration of a satellite according to an exemplary embodiment of the present invention.

FIG. 10 is a diagram illustrating a configuration of a terrestrial earth station according to an exemplary embodiment of the present invention.

FIG. 11 is a diagram illustrating a configuration of a terrestrial earth station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a terrestrial terminal may indicate a terminal, a mobile terminal (MT), a mobile station (MS), an advanced mobile station (AMS), a high reliability mobile station (HR-MS), a subscriber station (SS), a portable subscriber station (PSS), an access terminal (AT), and user equipment (UE), and may include an entire function or a partial function of the terminal, the MS, the MT, the AMS, the HR-MS, the SS, the PSS, the AT, and the UE.

Further, a terrestrial base station may indicate a base station (BS), an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) that performs a BS function, and an HR-RS that performs a BS function, and may include an entire function or a partial function of the BS, the ABS, the nodeB, the eNodeB, the AP, the RAS, the BTS, the MMR-BS, the RS, and the HR-RS.

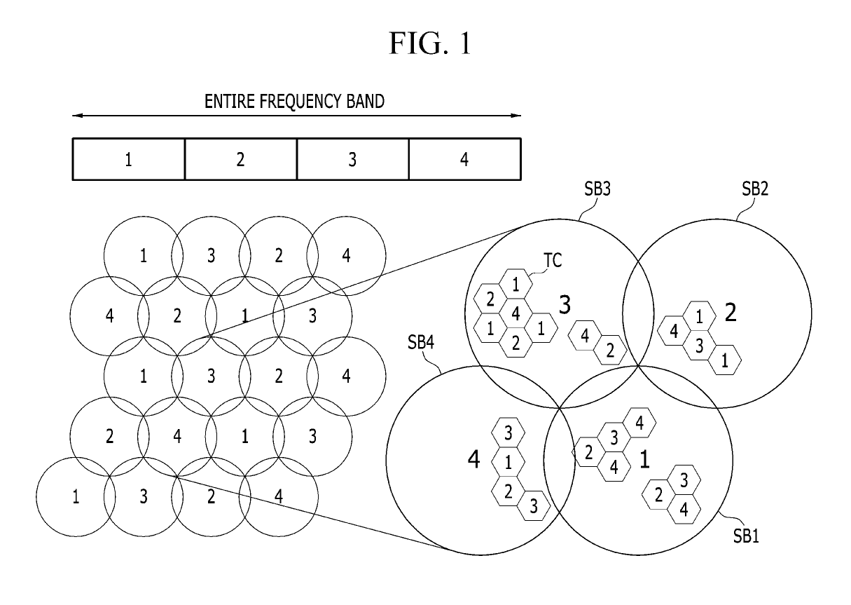

FIG. 1 is a diagram illustrating a method of dividing and using a frequency between a satellite communication system and a terrestrial communication system. When using a frequency that can be used in both of the satellite communication system and the terrestrial communication system, a method in which the satellite communication system and the terrestrial communication system divide and use the frequency may be considered. FIG. 1 illustrates an example in which the satellite communication system and the terrestrial communication system divide and use a frequency. The satellite communication system includes a satellite and a satellite terminal (e.g., a mobile earth station (MES). The terrestrial communication system includes a terrestrial base station and a terrestrial terminal. In a multiple beam environment, a satellite may radiate a plurality of satellite beams SB1 to SB4.

FIG. 1 illustrates a case in which an entire frequency band is divided into 4 (frequency bands 1 to 4). FIG. 1 illustrates a case in which a circular first satellite beam (SB1) uses a frequency band 1, a second satellite beam (SB2) adjacent to the SB1 uses a frequency band 2, a third satellite beam (SB3) uses a frequency band 3, and a fourth satellite beam (SB4) uses a frequency band 4. As shown in FIG. 1, the satellite communication system uses different frequency bands in the adjacent satellite beams SB1 to SB4.

When the SB1 uses a frequency band 1, a hexagonal terrestrial cell (TC) that is located within the SB1 may reuse frequency bands 2, 3, and 4. A TC may include M (M is a natural number) sectors. Similarly, the TC within the SB2 may reuse frequency bands 1, 3, and 4, the TC within the SB3 may reuse frequency bands 1, 2, and 4, and the TC within the SB4 may reuse frequency bands 1, 2, and 3. FIG. 1 illustrates a case in which the TC within the terrestrial cell (e.g., the SB1) uses one of frequency bands 2, 3, and 4 on a cell basis. However, this is an illustration, and when the terrestrial communication system is formed such that a frequency reuse factor of the terrestrial communication system is 1, each TC within the SB1 may use the entire frequency bands 2, 3, and 4.

When the terrestrial communication system within the SB1 reuses the frequency bands 2, 3, and 4, the terrestrial communication system within the SB2 using the frequency band 2 reuses frequency bands 1, 3, and 4. The satellite communication system and the terrestrial communication system share a frequency through this method. However, when the satellite terminal within the SB1 receives a downlink signal from the satellite, interference occurs by a downlink signal that is transmitted from many terrestrial base stations within adjacent satellite beams SB2 to SB4 to the terminal.

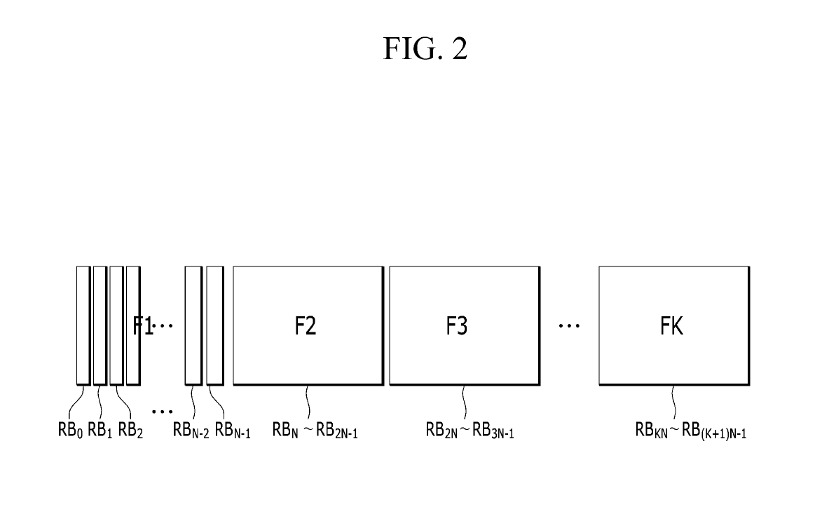

FIG. 2 is a diagram illustrating a frequency band in a satellite and terrestrial integrated network.

A frequency band that is used in a satellite and terrestrial integrated network may be divided into frequency bands F1 to FK according to a frequency reuse rate (or a frequency reuse factor) K of the satellite communication system.

In each satellite beam (e.g., SB1 to SB4), a corresponding frequency band of frequency bands F1 to FK is allocated and used according to a frequency reuse rate K. In this case, the frequency bands F1 to FK may be divided into N (N is the natural number) resource blocks (RB), respectively. For example, the frequency band F1 may include N resource blocks RB₀ to RB_{N-1}, the frequency band F2 may include N resource blocks RB_{N} to RB_{2N-1}, and the frequency band F3 may include N resource blocks RB_{2N} to RB_{3N-1}. At least one resource block is allocated to the satellite terminal and is used.

The terrestrial communication system uses the remaining frequency bands, except for a frequency band that is used in a satellite beam (e.g., SB1) at which a terrestrial base station of the terrestrial communication system is located. Therefore, the terrestrial communication system within one satellite beam (e.g., SB1) uses the remaining (K−1)*N resource blocks, except for N resource blocks that are allocated to a corresponding satellite beam (e.g., SB1) in the entire resource block number (K*N). The remaining (K−1)*N resource blocks are divided to not be overlapped to M sectors of a corresponding TC and are allocated.

When a set of the entire resource block is U, when a set of a resource block that is allocated to a satellite beam i is Bᵢ, when a set of a resource block that is allocated to the TC within an area of the satellite beam i is Cᵢ, and when a set of a resource block that is allocated to a sector j of the TC is Stⱼ, U, Bᵢ, and Cᵢ are represented by Equation 1.

U={RB₀,RB₁,RB₂, . . . , RB_{KN-1}}

Bᵢ={RB_{iN},RB_{iN+1},RB_{iN+2}, . . . , RB_{(i+1)N-1}}

Cᵢ=U−Bᵢ( [symbol] ,C₁=St₀∪St₁∪St₂,φ=St₀∩St₁,φ=St₀∩St₁,φ=St₁∩St₂) (Equation 1)

In Equation 1, it is assumed that one TC includes three sectors.

In a specific satellite beam (e.g., SB1), when a satellite communication system uses a frequency band F1, a terrestrial communication system within an area of the corresponding satellite beam SB1 may use frequency bands F2 to FK. A satellite terminal that is located within a satellite beam to which the frequency band F1 is allocated receives allocation of at least one of resource blocks RB₀-RB_{N-1} that are included in the frequency band F1 by a satellite (or a terrestrial earth station) and uses the resource block. In this case, because many terrestrial base stations that are located within an adjacent satellite beam area perform downlink transmission using the same frequency resource block as a resource block that the satellite terminal uses, interference occurs between the satellite communication system and the terrestrial communication system. In a satellite (e.g., an on board processing (OBP) satellite) having a signal processing function, the satellite performs a resource allocation operation. However, when the satellite does not have a signal processing function, the terrestrial earth station of the satellite communication system performs a resource allocation operation instead of the satellite. Specifically, the satellite receives a signal from the satellite terminal and transmits the signal to the terrestrial earth station. The terrestrial earth station performs a signal processing operation of the received signal and transmits the processed signal to the satellite.

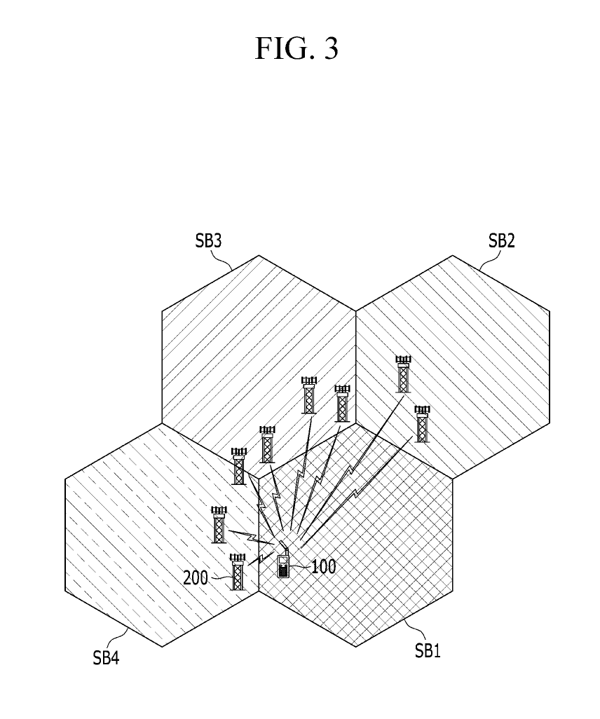

FIG. 3 is a diagram illustrating received signal interference of a satellite terminal 100 by a terrestrial base station 200. FIG. 3 illustrates the satellite beams SB1 to SB4 as hexagons. FIG. 3 illustrates a case in which the satellite terminal 100 that is located within the SB1 receives interference from the terrestrial base station 200 that is located in an area of adjacent satellite beams SB2 to SB4.

The terrestrial base station 200 of an area of the adjacent satellite beams SB2 to SB4 may be used to provide the same resource block as the resource block that is allocated to the satellite terminal 100 of an area of the SB1 and a service to a terrestrial terminal that is located within the corresponding TC. Downlink signals of such a terrestrial base station 200 are operated as interference to a satellite downlink signal of the satellite terminal 100. Because a distance between the terrestrial base station 200 and the satellite terminal 100 is considerably long, even if signal intensity of one terrestrial base station 200 is weak, an area of the SB1 is much larger than that of the TC and thus many signals of the terrestrial base station 200 are combined and such combined signals may operate as serious interference to the satellite terminal 100. In order to mitigate such interference, there are a method in which the satellite allocates a resource block in which intensity of an interference signal by the terrestrial base station 200 is weak to the satellite terminal 100, and a method in which the terrestrial base station 200 allocates a resource block that is allocated to an adjacent satellite beam to a terrestrial terminal in low priority order.

### 1. Method of Allocating Resource of Satellite

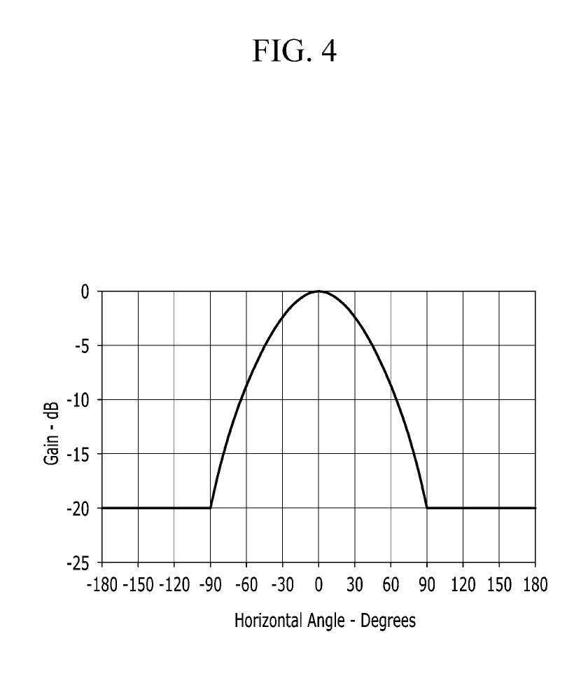

FIG. 4 is a diagram illustrating a sector antenna radiation pattern of the terrestrial base station 200.

Each terrestrial base station 200 within one TC divides a resource block on a sector basis of the TC, and allocates at least one of resource blocks that are allocated to each sector to a terrestrial terminal that is located at each sector of the TC. A sector antenna radiation pattern of the terrestrial base station 200 is defined in 3GPP TR 36.942 and is represented by Equation 2.

$$A ( θ ) = - min [ 12 {( \frac{θ}{{θ}_{3 d B}} )}^{2} , {A}_{m} ] where \\ - 180 \leq θ \leq 180 \qquad ( Equation 2 )$$

In Equation 2, A(θ) represents an antenna gain, θ_{3dB} represents a 3 dB beam width (e.g., 65°), and Aₘ represents a maximum attenuation value (e.g., 20 dB). An antenna beam pattern of the terrestrial base station 200 is represented by a graph of FIG. 4.

In a sector antenna pattern of the terrestrial base station 200 that is shown in FIG. 4, within about ±60° from the center of each sector of the TC, about −10 dB attenuation occurs, and within ±90° from the center of each sector of the TC, −20 dB maximum attenuation occurs. Therefore, the satellite allocates a resource block that is allocated to a sector in which an angle between the satellite terminal 100 and the center of a sector of sectors of a terrestrial cell within adjacent satellite beams SB2 to SB4 that give interfere to the satellite terminal 100 is equal to or larger than a threshold angle (e.g., 60°) to the satellite terminal 100. Alternatively, the satellite allocates a resource block that is allocated to a sector in which an angle between the satellite terminal 100 and the center of a sector of sectors of a terrestrial cell within adjacent satellite beams SB2 to SB4 that give interfere to the satellite terminal 100 is largest to the satellite terminal 100. Thereby, interference that the satellite terminal 100 receives can be mitigated.

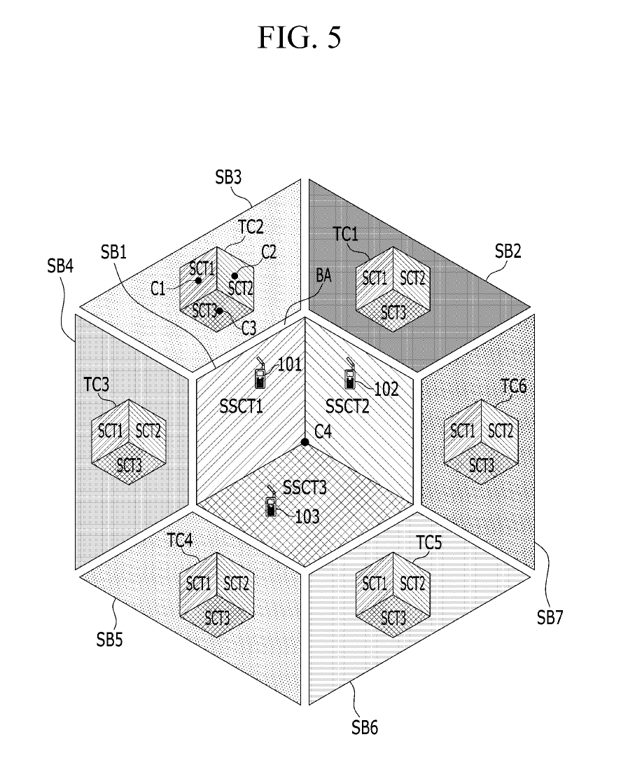

FIG. 5 is a diagram illustrating a method of allocating a resource of a satellite according to an exemplary embodiment of the present invention. In a multiple beam environment, one satellite may radiate a plurality of satellite beams SB1 to SB7. For convenience of description, FIG. 5 illustrates a case in which each of the terrestrial cells TC1 to TC6 includes three sectors SCT1 to SCT3. FIG. 5 illustrates a portion of each of satellite beams SB2 to SB7 adjacent to the SB1. Hereinafter, a method of allocating a resource of a satellite for mitigating interference that satellite terminals 101, 102, and 103 within the SB1 receive will be described. A frequency resource different from a frequency resource that is allocated to the SB1 is allocated to the SB1 and the adjacent satellite beams SB2 to SB7. Different frequency resources may be allocated to directly adjacent satellite beams among the satellite beams SB2 to SB7, and the same frequency resource may be allocated to satellite beams that are not directly adjacent.

First, the satellite divides an entire area of the SB1 into three sectors SSCT1 to SSCT3 similarly to the terrestrial cells TC1 to TC6. The satellite allocates the same resource block as a resource block that is allocated to sectors SCT1 to SCT3 of the terrestrial cells TC1 to TC6 within the adjacent satellite beams SB2 to SB7 to the satellite terminals 101, 102, and 103 that are located at each of the sectors SSCT1 to SSCT3 of the SB1. Hereinafter, for convenience of description, such resource allocation is referred to as “resource allocation on a sector basis”. For example, the satellite may allocate at least one of resource blocks that are allocated to the sector SCT1 of the terrestrial cells TC2 to TC6 within adjacent satellite beams SB2 to SB7 to a satellite terminal 101 that is located at the sector SSCT1 of the SB1. More specifically, the satellite selects the sector SCT1 in which an angle between the satellite terminal 101 and the center of each of sectors C1 to C3 among each of the sectors SCT1 to SCT3 of the TC2 is largest or is equal to or larger than a threshold angle, and allocates at least one of resource blocks that are allocated to the sector SCT1 to the satellite terminal 101. Similarly, the satellite may allocate at least one of resource blocks that are allocated to the sector SCT2 of the terrestrial cells TC2 to TC6 within the adjacent satellite beams SB2 to SB7 to a satellite terminal 102 that is located at the sector SSCT2 of the SB1. Similarly, the satellite may allocate at least one of resource blocks that are allocated to the sector SCT3 of the terrestrial cells TC2 to TC6 within the adjacent satellite beams SB2 to SB7 to a satellite terminal 103 that is located at the sector SSCT3 of the SB1. Thereby, an angle between the sectors SCT1 to SCT3 of the terrestrial base station 200 within the adjacent satellite beams SB2 to SB7 and the satellite terminals 101 to 103 using the same frequency resource block maintains a threshold angle or more. Finally, a signal of the terrestrial base station 200 is attenuated according to an antenna radiation pattern to be received by the satellite terminals 101 to 103 and thus interference that the satellite terminals 101 to 103 receive by a downlink signal of the terrestrial base station 200 is mitigated.

As the satellite terminals 101 to 103 locate adjacent to a boundary BA of the SB1, in a downlink in which the satellite terminals 101 to 103 receive a signal from the satellite, interference that is received from the terrestrial base station 200 increases. This is because, as a distance between the satellite terminals 101 to 103 and the terrestrial base station 200 is small, free space loss of a transmitting downlink signal of the terrestrial base station 200 is small and thus signal attenuation relatively decreases. Finally, as the satellite terminals 101 to 103 are adjacent to the boundary BA of the SB1, a downlink signal of the terrestrial base station 200 operates as larger interference to the satellite terminals 101 to 103. Therefore, the satellite communication system according to an exemplary embodiment of the present invention does not apply the above-described resource allocation on a sector basis to an entire satellite terminal within the SB1, and may be designed to apply resource allocation on a sector basis only to a satellite terminal that is located within a first threshold distance from the boundary BA of the SB1 or to a satellite terminal that is separated by a second threshold distance or more from a center C4 of the SB1. Because the number of resource blocks that may be allocated to the sectors SSCT1 to SSCT3 of the SB1 is limited, like a case in which the satellite terminals are concentrated at any one sector (e.g., SSCT1), a case that should allocate a resource block having large interference to the satellite terminal may occur. When resource allocation on a sector basis is applied only to a satellite terminal (or a satellite terminal that is separated by a second threshold distance or more from a center C4 of the SB1) that is located within a first threshold distance from the boundary BA of the SB1, a resource block may be freely allocated to a satellite terminal that is located at a periphery of the center C4 of the SB1 and thus a restriction of resource allocation can be reduced.

When the satellite does not have a signal processing function, the terrestrial earth station instead of the satellite may perform the above-described method of allocating a resource of FIG. 5.

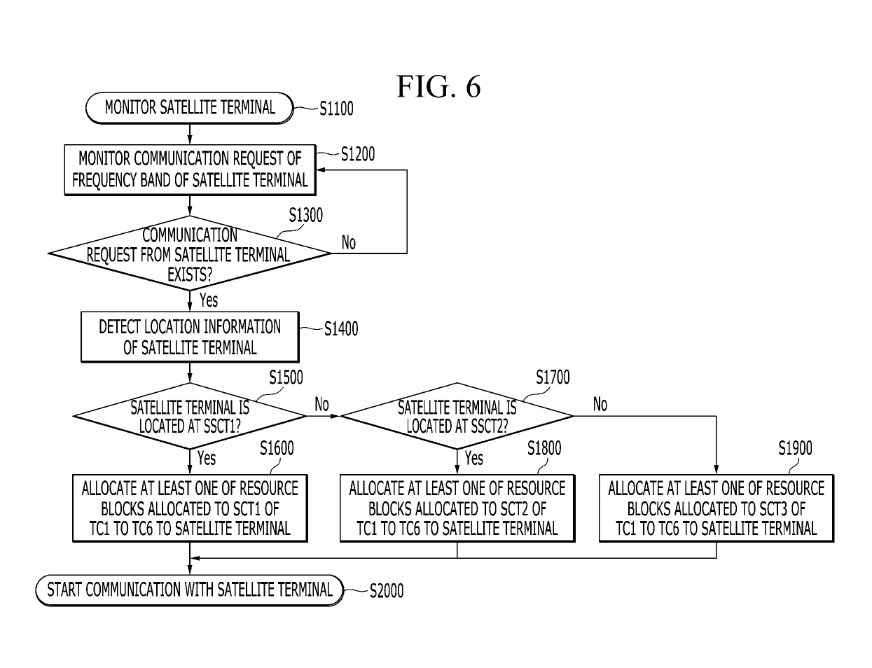

FIG. 6 is a flowchart illustrating a resource allocation process of a satellite according to an exemplary embodiment of the present invention. Referring to FIGS. 5 and 6, a resource allocation process of the satellite will be described.

First, the satellite monitors the satellite terminal (e.g., 101) (S1100).

The satellite monitors a communication request of a satellite frequency band of the satellite terminal 101 (S1200).

The satellite determines whether a communication request from the satellite terminal 101 exists (S1300), and if a communication request from the satellite terminal 101 exists, the satellite detects location information of the satellite terminal 101 (S1400). When the satellite terminal 101 sends a communication request to the satellite, the satellite terminal 101 transmits location information thereof to the satellite. For example, at initial access of satellite communication, the satellite terminal 101 may transmit location information to the satellite using GPS, and may periodically update a location during the satellite communication.

The satellite identifies which one of the sectors SSCT1 to SSCT3 of the SB1 the satellite terminal 101 is located at based on the detected location information of the satellite terminal 101. The satellite determines whether the satellite terminal 101 is located at the sector SSCT1 (S1500), and if the satellite terminal 101 is located at the sector SSCT1, the satellite allocates at least one of resource blocks that are allocated to the sector SCT1 of terrestrial cells TC1 to TC6 to the satellite terminal 101 (S1600). The satellite determines whether the satellite terminal 101 is located at the sector SSCT2 (S1700), and if the satellite terminal 101 is located at the sector SSCT2, the satellite allocates at least one of resource blocks that is allocated to the sector SCT2 of the terrestrial cells TC1 to TC6 to the satellite terminal 101 (S1800). If the satellite terminal 101 is located at the sector SSCT3, the satellite allocates at least one of resource blocks that are allocated to the sector SCT3 of the terrestrial cells TC1 to TC6 to the satellite terminal 101 (S1900).

The satellite starts communication with the satellite terminal 101 using a resource block that is allocated to the satellite terminal 101 (S2000).

When the satellite does not have a signal processing function, the terrestrial earth station may perform the above-described resource allocation process of FIG. 6 instead of the satellite.

In the foregoing description, a method of mitigating interference between the satellite communication system and the terrestrial communication system through resource allocation on a sector basis of the satellite has been described. Hereinafter, a method of allocating a resource of the terrestrial base station 200 for mitigating interference between the satellite communication system and the terrestrial communication system will be described.

### 2. Method of Allocating Resource of Terrestrial Base Station 200

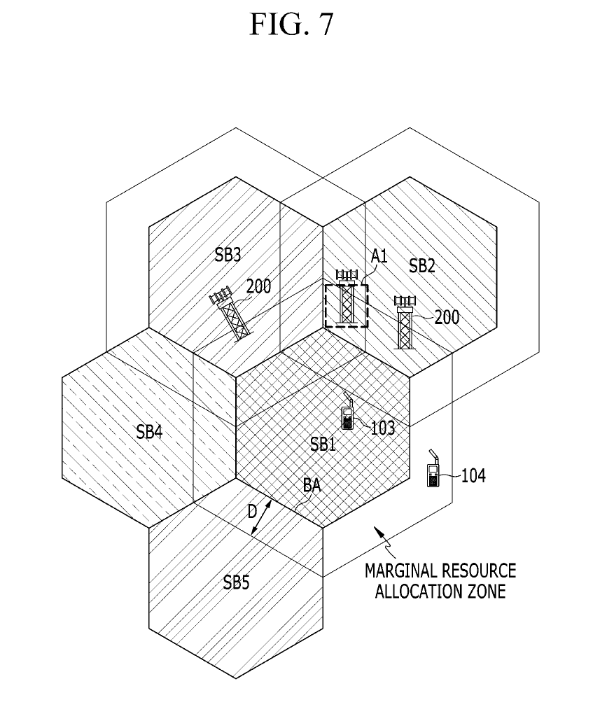

FIG. 7 is a diagram illustrating a method of allocating a resource of the terrestrial base station 200 according to an exemplary embodiment of the present invention. Hereinafter, for convenience of description, a method in which the terrestrial base station 200 that is located within satellite beams SB2 to SB5 allocates a frequency resource to a terrestrial terminal will be described.

By allocating a resource block that is allocated to a satellite beam (e.g., SB1) adjacent to the terrestrial base station 200 to the terrestrial terminal in low priority order, the terrestrial base station 200 may mitigate interference between the satellite communication system and the terrestrial communication system. Specifically, the terrestrial base station 200 preferentially allocates the remaining resource blocks except for a resource block that is allocated to an adjacent satellite beam SB1 among available resource blocks to the terrestrial terminal, and when an additional allocation request exists, the terrestrial base station 200 allocates an excluded resource block (resource block allocated to the SB1) to the terrestrial terminal.

There is little chance of a case in which each terrestrial base station 200 provides a service by simultaneously allocating all available resource blocks to the terrestrial terminal. Therefore, the terrestrial base station 200 can allocate a resource block that can give interference to satellite terminals 103 and 104 as late as possible.

As the satellite terminal 103 is located adjacent to a boundary BA of the SB1, the satellite terminal 103 receives much downlink interference caused by the terrestrial base station 200 within adjacent satellite beams SB2 to SB5. Therefore, the above-described method of allocating a resource of the terrestrial base station 200 may be limitedly applied only to the terrestrial base station 200 within a third threshold distance D from a satellite beam boundary BA. Here, a zone within a third threshold distance D from the satellite beam boundary BA is referred to as a marginal resource allocation zone. Specifically, the terrestrial base station 200 that is located within the marginal resource allocation zone preferentially allocates the remaining resource blocks except for a resource block that is allocated to an adjacent satellite beam (e.g., SB1) among available resource blocks to the terrestrial terminal, and when there is an additional allocation request (e.g., when a resource block to allocate is insufficient), the terrestrial base station 200 allocates a resource block that is allocated to an adjacent satellite beam (e.g., SB1) to the terrestrial terminal.

Therefore, because the number of the terrestrial base stations 200 of the terrestrial communication system using the same resource block as a resource block that the satellite terminal 103 uses decreases through the above-described method of allocating a resource of the terrestrial base station 200, downlink receiving interference of the satellite terminal 103 can be mitigated.

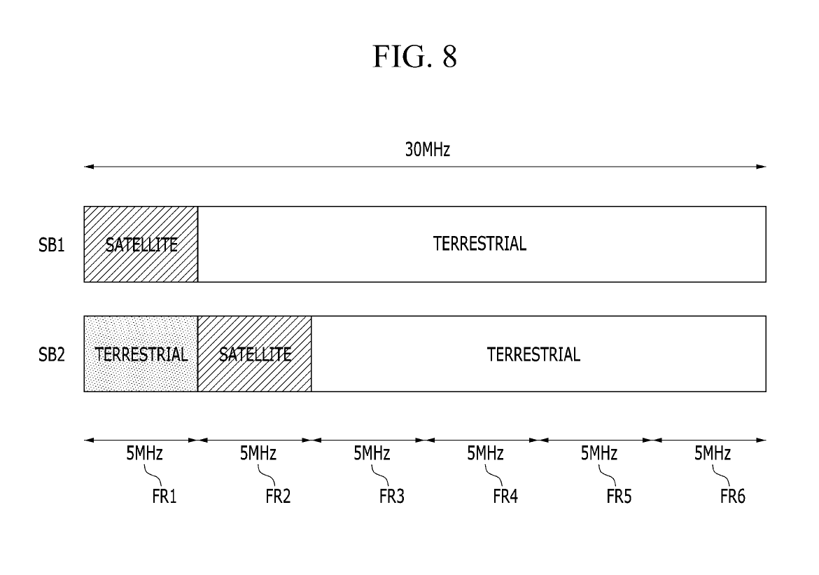

FIG. 8 is a diagram illustrating an example of frequency resource allocation between two adjacent satellite beams SB1 and SB2 of FIG. 7. For convenience of description, FIG. 8 illustrates a case in which an entire band width of a frequency is 30 MHz, and in which 5 MHz is allocated to each of satellite beams SB1 to SB5 and in which 25 MHz is used in the TC. In FIG. 8, it is assumed that a resource block of a frequency band FR1 of frequency bands FR1 to FR6 is allocated to the SB1 and a resource block of a frequency band FR2 is allocated to the SB2. It is assumed that 25 resource blocks are included in 5 MHz.

The terrestrial base station 200 that is located within a marginal resource allocation zone of the SB2 preferentially allocates a resource block of the remaining frequency bands FR3 to FR6 except for a resource block of frequency bands FR1 and FR2 to the terrestrial terminal, and only when there is an additional allocation request, the terrestrial base station 200 allocates a resource block of the frequency band FR1 that is allocated to the SB1 to the terrestrial terminal. Because the terrestrial base station 200 within the SB2 allocates 25 resource blocks of 125 resource blocks in low priority order in consideration of only the SB1, the terrestrial base station 200 does not give interference to a satellite terminal (e.g., 103) of the adjacent SB1 up to a resource available rate of 80% (=100/125*100).

Because the terrestrial base station 200 that is located at a zone (e.g., A1) in which the boundary BA of the first to third satellite beams SB1 to SB3 is overlapped allocates 50 resource blocks that are allocated to the SB1 and SB3 in low priority order, the terrestrial base station 200 does not give interference to a satellite terminal of the adjacent satellite beams SB1 and SB3 up to a resource available rate of 60% (=75/125*100).

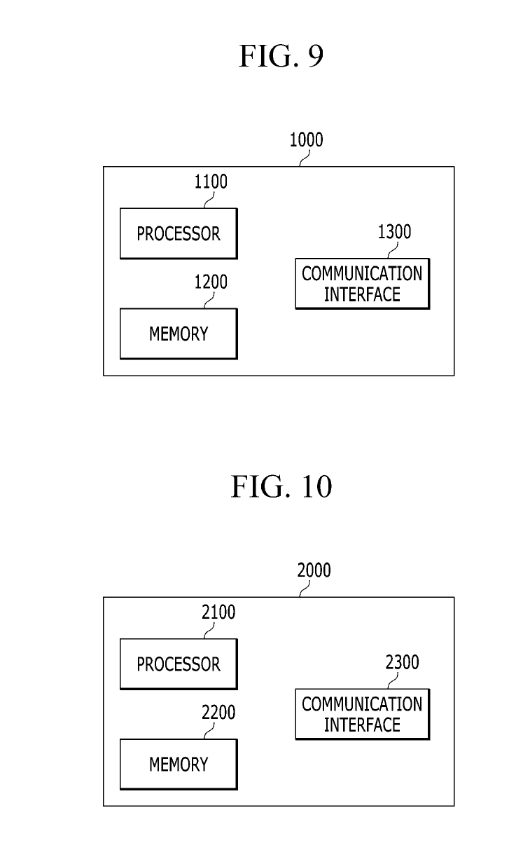

FIG. 9 is a diagram illustrating a configuration of a satellite 1000 according to an exemplary embodiment of the present invention.

The satellite 1000 includes a processor 1100, a memory 1200, and a communication interface 1300.

The processor 1100 may be formed to embody a function, procedure, and method that are described with reference to FIGS. 1 to 6.

The memory 1200 is connected to the processor 1100 and stores various information that is related to operation of the processor 1100.

The communication interface 1300 is connected to the processor 1100 and supports a function and operation for satellite communication.

FIG. 10 is a diagram illustrating a configuration of a terrestrial earth station 2000 according to an exemplary embodiment of the present invention. When the satellite 1000 does not have a signal processing function, the terrestrial earth station 2000 may allocate a resource instead of the satellite 1000.

The terrestrial earth station 2000 includes a processor 2100, a memory 2200, and a communication interface 2300.

The processor 2100 may be formed to embody a function, procedure, and method that are described with reference to FIGS. 1 to 6.

The memory 2200 is connected to the processor 2100 and stores various information that is related to operation of the processor 2100.

The communication interface 2300 is connected to the processor 2100 and supports a function and operation for satellite communication.

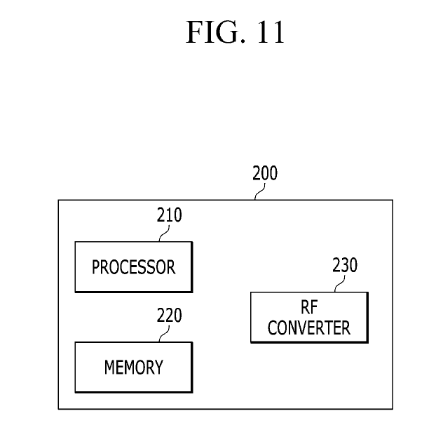

FIG. 11 is a diagram illustrating a configuration of the terrestrial base station 200 according to an exemplary embodiment of the present invention.

The terrestrial base station 200 includes a processor 210, a memory 220, and a radio frequency (RF) converter 230.

The processor 210 may be formed to embody a function, procedure, and method that are described with reference to FIGS. 7 and 8.

The memory 220 is connected to the processor 210 and stores various information that is related to operation of the processor 210.

The RF converter 230 is connected to the processor 210 and transmits or receives a wireless signal. The terrestrial base station 200 may have a single antenna or multiple antennas.

According to an exemplary embodiment of the present invention, in a satellite and terrestrial integrated network, in an environment in which a satellite communication system and a terrestrial communication system share and use a frequency, received signal interference of a satellite terminal occurring by a downlink signal that is transmitted from the terrestrial base station can be mitigated.

Further, according to an exemplary embodiment of the present invention, by minimizing downlink interference that the satellite terminal receives, entire frequency use can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a satellite or a terrestrial earth station that is included in a satellite communication system that shares a frequency resource with a terrestrial communication system allocates a frequency resource, the method comprising:
dividing an area of a first satellite beam into at least one sector;
determining a first sector at which a satellite terminal is located among the at least one sector;
determining a second sector corresponding to the first sector among at least one sector that is included in a first terrestrial cell; and
allocating at least one of first frequency resources for the second sector to the satellite terminal,
wherein the first terrestrial cell is located within an area of a second satellite beam adjacent to the first satellite beam.

2. The method of claim 1, wherein the number of sectors that are included in the first terrestrial cell is N (N is a natural number), and
the dividing of an area comprises dividing the area of the first satellite beam into N areas.

3. The method of claim 2, wherein a frequency resource that is allocated to the first satellite beam is different from a frequency resource that is allocated to the second satellite beam.

4. The method of claim 3, wherein remaining frequency resources, except for a frequency resource that is allocated to the second satellite beam, among at least one frequency resource are divided into the N number of sectors that are included in the first terrestrial cell.

5. The method of claim 4, wherein the determining of a second sector comprises determining a sector in which interference intensity with the satellite terminal is weakest among the N number of sectors that are included in the first terrestrial cell as the second sector.

6. The method of claim 4, wherein the determining of a second sector comprises measuring an angle between a center of each sector that is included in the first terrestrial cell and the satellite terminal.

7. The method of claim 6, wherein the determining of a second sector further comprises determining a sector having a larger angle than a threshold angle among the measured angles as the second sector.

8. The method of claim 6, wherein the determining of a second sector further comprises determining a sector having a largest angle among the measured angles as the second sector.

9. The method of claim 1, wherein the satellite terminal is separated by a threshold distance or more from a center of the first satellite beam.

10. A satellite that is included in a satellite communication system that shares a frequency resource with a terrestrial communication system, the satellite comprising:
a memory; and
a processor that is connected to the memory and that performs operation for allocating a frequency resource to a satellite terminal,
wherein the processor determines a first sector at which a satellite terminal is located among N (N is a natural number) sectors that are included in a first satellite beam of the satellite, determines a second sector corresponding to the first sector among N sectors that are included in a first terrestrial cell of the terrestrial communication system, and allocates at least one of frequency resources for the second sector to the satellite terminal, and
wherein the first terrestrial cell is located within an area of a second satellite beam of the satellite adjacent to the first satellite beam.

11. The satellite of claim 10, wherein a frequency resource that is allocated to the first satellite beam is different from a frequency resource that is allocated to the second satellite beam.

12. The satellite of claim 11, wherein remaining frequency resources, except for a frequency resource that is allocated to the second satellite beam, among at least one frequency resource are divided into the N number of sectors that are included in the first terrestrial cell.

13. The satellite of claim 12, wherein the processor measures an angle between a center of each sector that is included in the first terrestrial cell and the satellite terminal.

14. The satellite of claim 13, wherein the processor determines a sector having a larger angle than a threshold angle among the measured angles as the second sector.

15. The satellite of claim 10, wherein the satellite terminal is located within a threshold distance from a boundary of the first satellite beam.

16. A method in which a base station (BS) of a terrestrial communication system that shares a frequency with a satellite communication system allocates a frequency resource, the method comprising:
determining a frequency resource that is allocated to a second satellite beam adjacent to a first satellite beam at which the BS is located; and
allocating at least one of first frequency resources, except for frequency resources that are allocated to the first satellite beam and the second satellite beam among M (M is the natural number of 2 or more) frequency resources, to at least one terrestrial terminal of the terrestrial communication system.

17. The method of claim 16, wherein a frequency resource that is allocated to the first satellite beam is different from a frequency resource that is allocated to the second satellite beam.

18. The method of claim 17, further comprising allocating at least one of frequency resources that are allocated to the second satellite beam to at least one terrestrial terminal of the terrestrial communication system, when a frequency resource to allocate is insufficient.

19. The method of claim 18, wherein the BS is located within a threshold distance from a boundary of the second satellite beam.

20. The method of claim 16, wherein the allocating of at least one of first frequency resources comprises excluding a frequency resource that is allocated to a third satellite beam adjacent to the first satellite beam from the first frequency resource.
